(19) United States
(12) Patent Application Publication
(10) Pub. No.: US 2024/0331092 A1
(43) Pub. Date: Oct. 3, 2024

(54) IMAGE PROCESSING DEVICE, IMAGE PROCESSING METHOD, AND NON-TRANSITORY STORAGE MEDIUM

(71) Applicant: LAPIS Technology Co., Ltd., Yokohama-shi (JP)

(72) Inventors: Naoki NISHITANI, Yokohama-shi (JP); Yuki IMATOH, Yokohama-shi (JP)

(73) Assignee: LAPIS Technology Co., Ltd., Yokohama-shi (JP)

(21) Appl. No.: 18/621,917

(22) Filed: Mar. 29, 2024

(30) Foreign Application Priority Data
Mar. 30, 2023 (JP) 2023-056755

(51) Int. Cl. G06T 5/40

(52) U.S. Cl. CPC G06T 5/40; G06T 2207/30252

(57) ABSTRACT

An image processing device includes a memory, and a processor coupled to the memory, the processor is configured to: acquire an image aiding a field of view of a driver of a vehicle, and time information of a point in time when the image was captured; select, from a plurality of conversion functions that convert luminance of the image using mutually different characteristics and that include two or more time band specific conversion functions determined specifically for time bands in a one day period, two or more of the conversion functions including at least one of the two or more time band specific conversion functions according to the time information; generate a synthesized function using the two or more conversion functions selected; and convert the luminance of the image using the synthesized function.

### CROSS-REFERENCE TO RELATED APPLICATION

This application is based on and claims priority under 35 USC 119 from Japanese Patent Application No. 2023-056755 filed on Mar. 30, 2023, the disclosure of which is incorporated by reference herein.

### BACKGROUND

### Technical Field

Technology disclosed herein relates to an image processing device, an image processing method, and a non-transitory storage medium.

### Related Art

Recently, instead of a mirror installed to a vehicle, systems (so-called electronic mirrors) are becoming common that project a video image captured by a camera of an area that would be projected by a mirror onto a display. Generally there is a need to adjust the gradation by pixel in a video image obtained by a camera because the number of gradations (the dynamic range) of the display is smaller than the number of gradations of a camera. As a method employed therefor, a known method called tone mapping performs conversion according to human visual characteristics.

For example, Japanese Patent Application Laid-Open (JP-A) No. 2021-093608 discloses correction using a global tone mapping tone curve to convert a picture quality of live images of an imaging subject to a picture quality having a brightness near to the appearance as sensed by a person when directly viewing live images. Global tone mapping is a method to convert luminance uniformly for an entire image. Moreover, JP-A No. 2021-093608 discloses converting image quality of live images using a tone curve corresponding to an environment (illumination) when captured from out of tone curves respectively corresponding to a brightness of a place in the sun, a brightness of a place in the shade, and a brightness under a cloudy sky.

Moreover, for example as disclosed in JP-A 2003-309763, there is disclosure of detecting whether or not there is a scene change from an image group, computing a gradation conversion curve when a scene change has been detected, synthesizing this gradation conversion curve together with a past gradation conversion curve, and performing gradation conversion for each image using the synthesized gradation conversion curve.

However, a luminance distribution of an image obtained by an onboard camera changes according to time bands of daytime and nighttime, changes according to vehicle travel location such as an urban area, a mountainous area, a tunnel or the like, and also changes according to whether the weather is sunny, cloudy, or rainy. In the technology disclosed in JP-A No. 2021-093608, due to selecting a tone curve according to illumination when captured, sometimes this can lead to an unsettling feeling in images after gradation conversion, particularly in situations in which there is a mismatch between the illumination with respect to the time band (for example, during travel through a tunnel, in an underground car park or the like).

Technology disclosed herein provides an image processing device, an image processing method, and a non-transitory storage medium that are capable of performing gradation conversion on the image according to time band.

### SUMMARY

An image processing device according to a first aspect includes a memory, and a processor coupled to the memory. The processor is configured so as to acquire an image aiding a field of view of a driver of a vehicle and time information of a point in time when the image was captured, select, from plural conversion functions that convert luminance of the image using mutually different characteristics and that include two or more time band specific conversion functions determined specifically for time bands in a one day period, two or more of the conversion functions including at least one of the two or more time band specific conversion functions according to the time information, generate a synthesized function using the two or more conversion functions selected, and convert the luminance of the image using the synthesized function.

An image processing method according to a second aspect includes, acquiring an image aiding a field of view of a driver of a vehicle, and time information of a point in time when the image was captured, selecting, from plural conversion functions that convert luminance of the image using mutually different characteristics and that include two or more time band specific conversion functions determined specifically for time bands in a one day period, two or more of the conversion functions including at least one of the two or more time band specific conversion functions according to the time information, generating a synthesized function using the two or more conversion functions selected, and converting the luminance of the image using the synthesized function.

A non-transitory storage medium according to a third aspect is stored with a program executable by a computer so as to execute processing. The processing includes acquiring an image aiding a field of view of a driver of a vehicle, and time information of a point in time when the image was captured, selecting, from plural conversion functions that convert luminance of the image using mutually different characteristics and that include two or more time band specific conversion functions determined specifically for time bands in a one day period, by selecting two or more of the conversion functions including at least one of the two or more time band specific conversion functions according to the time information, generating a synthesized function using the two or more conversion functions selected, and converting the luminance of the image using the synthesized function.

### BRIEF DESCRIPTION OF THE DRAWINGS

An exemplary embodiment of the present disclosure will be described in detail based on the following figures, wherein:

FIG. 1 is a diagram illustrating an example of a schematic configuration of an image processing system;

FIG. 2 is a block diagram illustrating an example of a hardware configuration of an image processing device;

FIG. 3 is a diagram illustrating an example of a tone curve;

FIG. 4 is a block diagram illustrating an example of a functional configuration of an image processing device;

FIG. 5 is a diagram to explain functions of an image processing device; and

FIG. 6 is a flowchart illustrating an example of image processing.

### DETAILED DESCRIPTION

Technology disclosed herein exhibits the effect of enabling gradation conversion on an image according to time band.

Description follows regarding an exemplary embodiment of the present disclosure, with reference to the drawings. Note that the same reference numerals will be appended in the drawings to the same or equivalent configuration elements and parts.

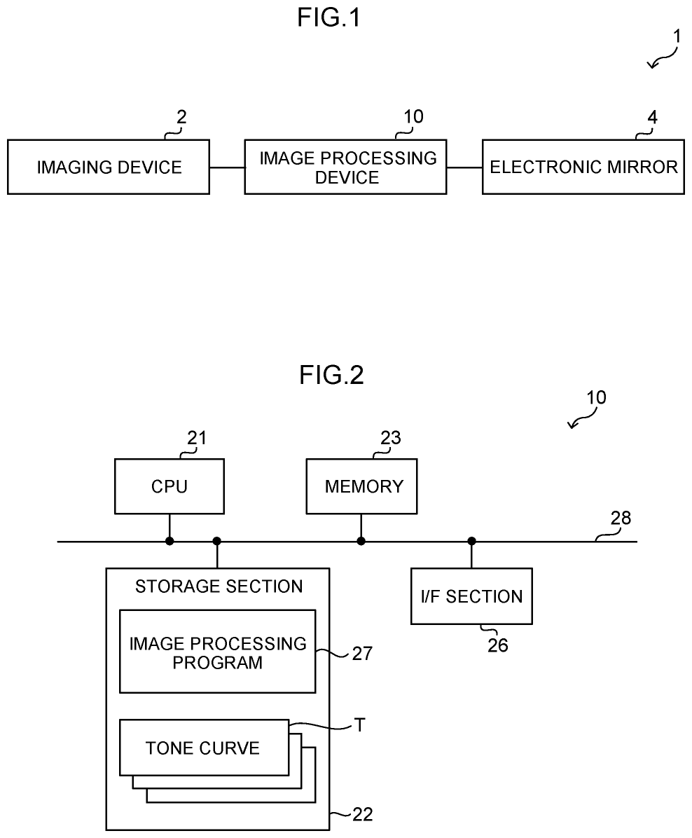

First description follows regarding a configuration of an image processing system 1, with reference to FIG. 1. FIG. 1 is a diagram illustrating a schematic configuration of the image processing system 1. As illustrated in FIG. 1, the image processing system 1 includes an imaging device 2, an image processing device 10, and an electronic mirror 4. The imaging device 2 and the image processing device 10, and the image processing device 10 and the electronic mirror 4, are configured so as to be connectable to each other either by wire or wirelessly via a network. The image processing system 1 is, for example, installed to a single vehicle.

The imaging device 2 captures images (for example an image rearward and/or an image sideward of a vehicle) aiding the field of view of a driver of the vehicle, and successively outputs the captured images to the image processing device 10. The imaging device 2 is, for example, a digital camera that performs imaging based on visible light configured including a complementary metal oxide semiconductor (CMOS) image sensor or a charge coupled device (CCD) image sensor.

The imaging device 2 preferably has a so-called High Dynamic Range (HDR) function. An HDR function is a function that, based on a high sensitivity captured image captured at high sensitivity and a low sensitivity captured image captured at low sensitivity, synthesizes the high sensitivity captured image and the low sensitivity captured image such that there is no clipping of overexposed bright portions and no clipping of underexposed dark portions. The HDR function enables an image having a large number of gradations (i.c. a wide dynamic range) to be output by an electronic mirror 4, described later.

The image processing device 10 converts images output from the imaging device 2 so as to match the number of gradations of the electronic mirror 4, and successively outputs the post-conversion images to the electronic mirror 4.

The electronic mirror 4 displays the images after gradation conversion output from the image processing device 10 toward the inside of a vehicle cabin. Namely, the electronic mirror 4 functions as a substitute for a vehicle rearview mirror and/or side mirror, and the driver is able to confirm the situation in the external environment of the vehicle by visually checking the images being displayed on the electronic mirror 4. The electronic mirror 4 is, for example, configured including a display such as a liquid crystal display or the like, and the number of gradations that are able to be displayed thereon is fewer than the number of gradations of the images captured by the imaging device 2 (i.c. the dynamic range is narrower).

However, a luminance distribution of images obtained by the onboard imaging device 2 changes according to time bands such as daytime or nighttime, changes according to whether the vehicle travel location is an urban area, a mountainous area, a tunnel or the like, and also changes according to whether the weather is sunny, cloudy, rainy or the like. When gradation conversion is performed based merely on such luminance distributions then this can sometimes lead to an unsettling feeling in that images after gradation conversion seem darker than they would appear in real life despite being in daytime, and feel brighter than they would appear in real life despite being in nighttime.

The image processing device 10 according to the present exemplary embodiment takes into consideration such conditions in the external environment (namely the luminance distribution of the images) and performs gradation conversion on the images according to time bands such as daytime and nighttime. Detailed explanation follows regarding the image processing device 10. In the following, an image having a large number of gradations input to the image processing device 10 from the imaging device 2 is called an “input image”, and an image having a small number of gradations output from the image processing device 10 to the electronic mirror 4 is called an “output image”.

First description follows regarding an example of a hardware configuration of the image processing device 10, with reference to FIG. 2. As illustrated in FIG. 2, the image processing device 10 includes a central processing unit (CPU) 21, a non-volatile storage section 22, a memory 23 serving as a temporary storage area, and an interface (I/F) section 26. The I/F section 26 performs wired or wireless communication with the imaging device 2, the electronic mirror 4, and other external devices and the like. The CPU 21, the storage section 22, the memory 23, and the I/F section 26 are connected together through a bus 28 such as a system bus or a control bus, so as to be able to exchange various information with each other.

The storage section 22 is, for example, implemented by a storage medium such as a hard disk drive (HDD), solid state drive (SSD), flash memory, or the like. An image processing program 27 of the image processing device 10 and various tone curves T are stored in the storage section 22. The CPU 21 reads the image processing program 27 from the storage section 22, and expands the image processing program 27 into the memory 23, and executes the expanded image processing program 27. The CPU 21 is an example of a processor of the present disclosure. Appropriate examples of devices applicable as the image processing device 10 include a personal computer, a server computer, a smartphone, a tablet terminal, a wearable terminal, and the like.

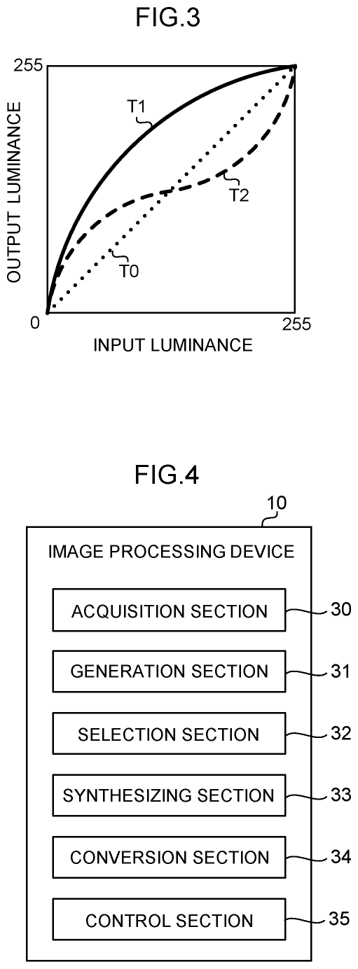

FIG. 3 illustrates tone curves TO, TI, and T2 as examples of the tone curves T. The tone curves T are conversion functions in which luminance values of each pixel of the input image are associated with the luminance values of each pixel of the output image. In the graph of FIG. 3, the input luminance is illustrated on the horizontal axis, and the output luminance is illustrated on the vertical axis, with such luminance expressed as values from 0 to 255, with larger values of luminance indicating greater brightness.

The tone curve T0 illustrated by the dotted line is a reference tone curve having a gradient of 1 for output luminance with respect to input luminance. On the other hand, in the tone curve Tl illustrated by the solid line, input luminances are associated with greater output luminances over the entire range. Performing gradation conversion employing the tone curve T1 results in an output image that is a brighter image as a whole than the input image. In the tone curve T2 illustrated by the dashed line, input luminances are associated with greater output luminances in a region where luminance values are small, and input luminances are associated with smaller output luminances in a region where luminance values are large. Performing gradation conversion employing the tone curve T2 results in an output image that is brighter than the input image in darker regions, and that is a darker image than the input image in brighter regions, with this being an image matching human visual characteristics.

The storage section 22 is pre-stored with plural conversion functions (tone curves T) for converting the luminance of input images using mutually different characteristics, such as the tone curves T0, T1, and T2. Specifically, two or more time band specific conversion functions determined for specific time bands across a one day period, for example daytime and nighttime conversion functions, are pre-stored as the plural tone curves T. Specifically, two or more illumination specific conversion functions determined specifically for illumination in the environment in which the input images were captured, for example light place and dark place conversion functions, are pre-stored as the plural tone curves T. Note that these may be combined as, for example, a tone curve T for daytime and light places, and a tone curve T for daytime and dark places, and may be pre-stored.

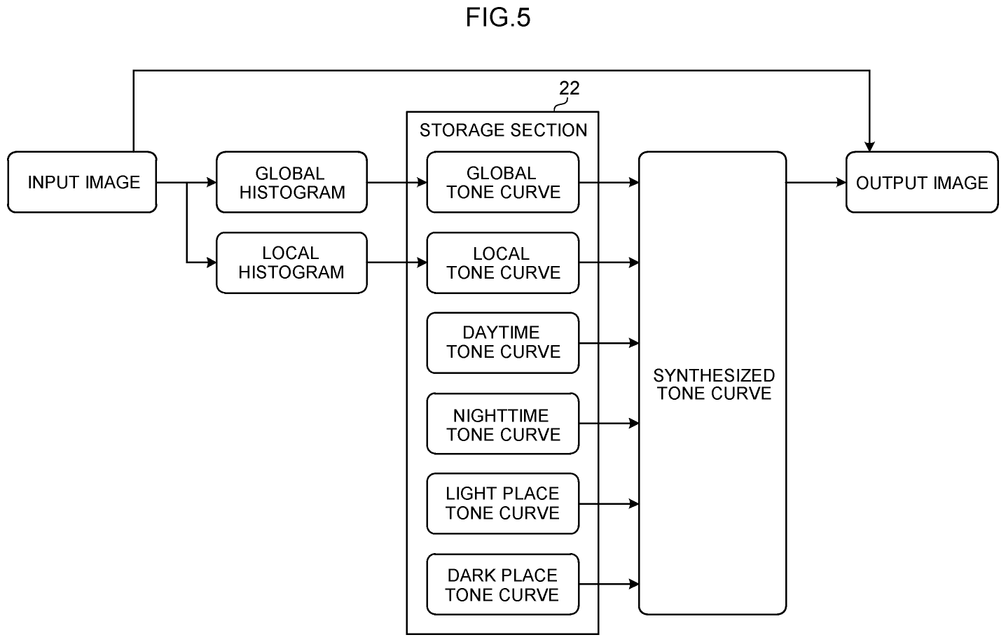

Next, description follows regarding an example of a functional configuration of the image processing device 10, with reference to FIG. 4 and FIG. 5. As illustrated in FIG. 4, the image processing device 10 includes an acquisition section 30, a generation section 31, a selection section 32, a synthesizing section 33, a conversion section 34, and a control section 35. The CPU 21 functions as each functional section of the acquisition section 30, the generation section 31, the selection section 32, the synthesizing section 33, the conversion section 34, and the control section 35 by the CPU 21 executing the image processing program 27. FIG. 5 is a diagram illustrating a flow by execution by each of the functional sections, up to conversion of an input image into an output image.

The acquisition section 30 acquires an input image from the imaging device 2. The input image is an image aiding the field of view of the driver of a vehicle as described above, and is an image having a greater number of gradations than the output image.

The acquisition section 30 acquires time information at the point in time when the input image was captured. The time information is, for example, expressed by year, month, day, hour, minute, and may be acquired via the I/F section 26 from the vehicle and a network time protocol (NTP) server or the like. Moreover, for example, the acquisition section 30 may estimate the time information based on an average luminance and/or a luminance distribution of all the pixels of plural input images captured in a predetermined time period (for example a period of 5 minutes), based on illumination information, and the like.

The acquisition section 30 also acquires illumination information indicating illumination in the environment in which the input images were captured. The illumination information may, for example, be measured by an illuminometer that detects illumination in the surroundings.

For the input images acquired by the acquisition section 30, the generation section 31 generates at least one out of a global tone curve for use in global tone mapping, or a local tone curve for use in local tone mapping. Global tone mapping is a method of converting luminance uniformly for the whole of an image. Local tone mapping is a method of converting luminance by part of an image, thereby enabling a conversion to an image that although being displayed with few gradations, has an appearance close to that of the naked eye, and hence is a more vivid image to the naked eye.

Specifically, the generation section 31 first generates a luminance histogram indicating a distribution of luminance for all the pixels in the input image (a global histogram). Then based on the global histogram of the input image, the generation section 31 generates a global conversion function (global tone curve) to convert luminance uniformly for the entire input image. The generation section 31 stores the generated global tone curve in the storage section 22.

Next, the generation section 31 generates a luminance histogram (local histogram) indicating a distribution of luminance for all pixels by part of the input image. Then based on the local histogram of the input image, the generation section 31 generates a local conversion function (local tone curve) to convert the luminance by part of the input image. The generation section 31 stores the generated local tone curve in the storage section 22.

Note that generation of the global tone curve and the local tone curve may be performed each time an input image is acquired (namely at the frame rate of the imaging device 2), and may be performed at predetermined time intervals (for example every five minutes). Performing the above processing results in, as illustrated in FIG. 5, storage in the storage section 22 of a daytime tone curve and a nighttime tone curve (time band specific conversion functions), a light place tone curve and a dark place tone curve (illumination specific conversion functions), a global tone curve, and a local tone curve.

From out of the plural conversion functions (tone curves) stored in the storage section 22, the selection section 32 then selects, according to the time information, two or more conversion functions including at least a time band specific conversion function.

For example, according to the time information the selection section 32 may select at least a time band specific conversion function and the global conversion function. For example, in cases in which the time information indicates that it is 12 noon, the selection section 32 may select the daytime tone curve and the global tone curve. As another example, in cases in which the time information indicates that it is 17:00 hours in the evening, the selection section 32 may select the daytime tone curve, the nighttime tone curve, and the global tone curve.

As an example, according to the time information the selection section 32 may select at least a time band specific conversion function and the local conversion function. For example, in cases in which the time information indicates that it is 12 noon, the selection section 32 may select the daytime tone curve and the local tone curve. Moreover as an example, in cases in which the time information indicates that it is 17:00 hours in the evening, the selection section 32 may select the daytime tone curve, the nighttime tone curve, and the local tone curve.

Moreover as an example, according to the time information the selection section 32 may select at least one time band specific conversion function, the global conversion function, and the local conversion function. Whether or not to select each of the global conversion function or the local conversion function may, for example, pre-designated by a user, or may be decided according to a luminance histogram for the entire input image and/or by part thereof.

Moreover as an example, from out of the plural conversion functions (tone curves) stored in the storage section 22 and according to illumination information, the selection section 32 may select two or more conversion functions including at least one illumination specific conversion functions. For example, in cases in which the time information indicates that it is 12 noon and the illumination information indicates that it is a dark place, the selection section 32 may select the daytime tone curve and the dark place tone curve. When doing so, the selection section 32 may furthermore select a combination thereof with the global tone curve and/or the local tone curve.

The synthesizing section 33 employs the two or more conversion functions selected by the selection section 32 and generates a synthesized function. The method of synthesis is not particularly limited and, for example, may be by taking the mean or a weighted average or the like of the two or more tone curves. For example, consider a case in which the time information indicates that it is 17:00 hours in the evening, and the daytime tone curve, the nighttime tone curve, and the local tone curve are selected by the selection section 32. In such a case the synthesizing section 33 may set a weight of the daytime tone curve to 0.5, a weight of the nighttime tone curve to 0.5, and a weight of the local tone curve to 1, and then generate a synthesized tone curve derived by taking a weighted average of these tone curves.

Moreover, for example, the synthesizing section 33 may synthesize by combining the daytime tone curve with the nighttime tone curve, and then synthesize by combining the resultant tone curve with the global tone curve and/or the local tone curve.

Conversion section 34 employs the synthesized function (synthesized tone curve) synthesized by the synthesizing section 33 to convert the luminance of the input image for output as the output image. Specifically, the conversion section 34 employs the synthesized function to convert the luminance values by pixel in the input image, so as to generate an output image in which the luminance values have been converted by pixel.

The control section 35 outputs the output image generated by the conversion section 34 to the electronic mirror 4.

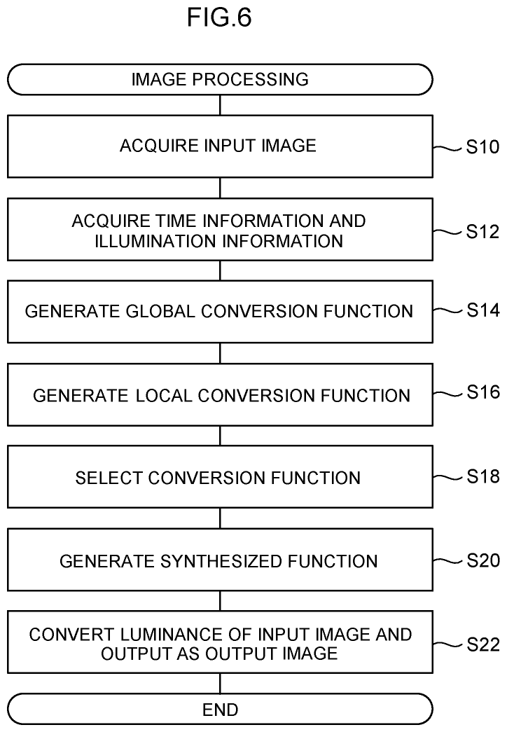

Next, description follows regarding operation of the image processing device 10 according to the present exemplary embodiment, with reference to FIG. 6. In the image processing device 10, the image processing illustrated in FIG. 6 is executed by the CPU 21 executing the image processing program 27. The image processing is, for example, repeatedly executed for each respective time an input image is input to the image processing device 10 from the imaging device 2.

At step S10, the acquisition section 30 acquires an input image aiding the field of view of the driver of the vehicle from the imaging device 2. At step S12, the acquisition section 30 acquires the time information and the illumination information at the point in time when the input image acquired at step S10 was captured. At step S14, the generation section 31 generates a global conversion function based on the input image acquired at step S10, and stores the global conversion function in the storage section 22. At step S16, the generation section 31 generates a local conversion function based on the input image acquired at step S10, and stores the local conversion function in the storage section 22.

At step S18, from out of the time band specific conversion functions, the illumination specific conversion functions, the global conversion function, and the local conversion function that are stored in the storage section 22, the selection section 32 selects two or more conversion functions including at least one time band specific conversion function based on the time information and the illumination information acquired at step S12. At step S20, the synthesizing section 33 employs the two or more conversion functions selected at step S18 to generate a synthesized function. At step S22, the conversion section 34 employs the synthesized function generated at step S20 to convert the luminance of the input image and to output this as the output image. The present image processing is ended when step S22 has been completed.

As described above, the image processing device 10 according to an exemplary embodiment of the present disclosure includes the acquisition section 30 that acquires an image aiding the field of view of a driver of the vehicle, and acquires the time information at the point in time when the image was captured. Moreover, the image processing device 10 also includes the selection section 32 that, from out of the plural conversion functions for converting luminance of an image using mutually different characteristics that include two or more time band specific conversion functions determined specifically to time bands in a one day period, selects two or more conversion functions including at least one out of the two or more time band specific conversion functions according to the time information. The image processing device 10 also includes the synthesizing section 33 that employs the two or more conversion functions selected to generate a synthesized function. Moreover, the image processing device 10 also includes the conversion section 34 that employs the synthesized function to convert the luminances of images. This thereby enables gradation conversion to be performed on images according to time bands.

Note that although in the above exemplary embodiment an example has been described for an embodiment in which the acquisition section 30 acquires illumination information, and uses illumination specific conversion functions to generate the synthesized function, there is no limitation thereto. The image processing device 10 may omit acquiring the illumination information or the like in cases in which illumination specific conversion functions are not employed to generate the synthesized function.

Moreover, the following types of processor may, for example, be employed as a hardware structure of a processing unit to execute each of the processing of the acquisition section 30, the generation section 31, the selection section 32, the synthesizing section 33, the conversion section 34, and the control section 35 in the exemplary embodiment described above. The types of processor referred to above include, in addition to a CPU that is a general purpose processor functioning as each type of the processing unit by executing software (a program) as described above, programmable logic devices (PLD) that are processors that allow circuit configuration to be modified post-manufacture, such as field-programmable gate arrays (FPGA), and dedicated electronic circuits, these being processors including a circuit configuration custom-designed to execute specific processing, such as an application specific integrated circuits (ASIC).

A single processing unit may be configured by any one of these types of processor, or may be configured by a combination of two or more of the same type or different types of processor (such as a combination of plural FPGAs, or a combination of a CPU and an FPGA). Plural processing units may also be configured by a single processor.

Examples in which plural processing units are configured by a single processor include a first embodiment in which a single processor is configured by a combination of one or more CPU and software as typified by a computer such as a client or server, and this processor functions as the plural processing units. A second example is one in which a processor is employed to implement the functions of the entire system including the plural processing units using a single integrated circuit (IC) chip, as typified by a system on chip (SOC) or the like. In this manner, the types of processing units are configured using one or more of the above types of processor as hardware structure.

Furthermore, more specifically circuitry that combines circuit elements, such as a semiconductor elements or the like may be employed as hardware structure of these types of processor.

Moreover, although in the above exemplary embodiment an example has been described in which the image processing program 27 of the image processing device 10 is pre-stored on the storage section 22, there is no limitation thereto. The image processing program 27 may be provided in a format recorded on a recording medium, such as a compact disc read only memory (CD-ROM), digital versatile disc read only memory (DVD-ROM), universal serial bus (USB) memory, or the like. Moreover, the image processing program 27 may be in a format downloadable from an external device over a network. Furthermore, the technology disclosed herein also encompasses, in addition to a program, a non-transitory storage medium stored with a program.

The technology disclosed herein may be implemented by any appropriate combination of the above exemplary embodiments and examples. The content disclosed above and the content of the drawings are detailed explanations of parts related to the technology disclosed herein, and are no more than examples of the technology disclosed herein. For example, description above related to configuration, function, operation, and advantageous effects is merely description related to an example of configuration, function, operation, and advantageous effects of parts according to the technology disclosed herein. This means that unnecessary parts may be omitted from, new elements may be added to, and replacements may be made in the content disclosed above and the content of the drawings within a range not departing from the spirit of the technology disclosed herein.

The following supplements are also disclosed in related to the above exemplary embodiment.

### Supplement 1

An image processing device including:
an acquisition section that acquires an image aiding a field of view of a driver of a vehicle, and time information of a point in time when the image was captured;
a selection section that, from plural conversion functions that convert luminance of the image using mutually different characteristics and that include two or more time band specific conversion functions determined specifically for time bands in a one day period, selects two or more of the conversion functions including at least one of the two or more time band specific conversion functions according to the time information;
a synthesis section that generates a synthesized function using the two or more conversion functions selected; and
a conversion section that converts the luminance of the image using the synthesized function.

### Supplement 2

An image processing device of supplement 1, wherein:
the plural conversion functions include two or more illumination specific conversion functions determined specifically for illumination in an environment captured by the image; and
the acquisition section acquires illumination information indicating illumination in the environment captured by the image; and
the selection section selects, from the plural conversion functions, two or more of the conversion functions including at least one of the illumination specific conversion functions according to the illumination information.

### Supplement 3

The image processing device of supplement 1 or supplement 2, wherein:
the plural conversion functions include a global conversion function that converts luminance uniformly for an entirety of the image; and
the selection section selects two or more of the conversion functions including at least one of the two or more time band specific conversion functions and the global conversion function.

### Supplement 4

The image processing device according to supplement 3, further including:
a generation section that generates the global conversion function based on a luminance histogram indicating a distribution of respective luminances for each pixel in the image.

### Supplement 5

The image processing device according to any one of supplement 1 to supplement 4, wherein:
the plural conversion functions include a local conversion function that converts luminance by part of the image; and
the selection section selects two or more of the conversion functions including at least one of the two or more time band specific conversion functions and the local conversion function.

### Supplement 6

The image processing device of claim 5, further including:
a generation section that generates the local conversion function based on a luminance histogram indicating a distribution of respective luminances for each pixel by part the image.

### Supplement 7

An image processing method of processing including:
acquiring an image aiding a field of view of a driver of a vehicle, and time information of a point in time when the image was captured;
selecting, from plural conversion functions that convert luminance of the image using mutually different characteristics and that include two or more time band specific conversion functions determined specifically for time bands in a one day period, two or more of the conversion functions including at least one of the two or more time band specific conversion functions according to the time information;
generating a synthesized function using the two or more conversion functions selected; and
converting the luminance of the image using the synthesized function.

### Supplement 8

An image processing program that causes a computer to execute processing including:
acquiring an image aiding a field of view of a driver of a vehicle, and time information of a point in time when the image was captured;
selecting, from plural conversion functions that convert luminance of the image using mutually different characteristics and that include two or more time band specific conversion functions determined specifically for time bands in a one day period, two or more of the conversion functions including at least one of the two or more time band specific conversion functions according to the time information;
generating a synthesized function using the two or more conversion functions selected; and
converting the luminance of the image using the synthesized function.

What is claimed is:

1. An image processing device comprising
a memory, and
a processor coupled to the memory, wherein the processor is configured to:
acquire an image aiding a field of view of a driver of a vehicle, and time information of a point in time when the image was captured;
select, from a plurality of conversion functions that convert luminance of the image using mutually different characteristics and that include two or more time band specific conversion functions determined specifically for time bands in a one day period, two or more of the conversion functions including at least one of the two or more time band specific conversion functions according to the time information;
generate a synthesized function using the two or more conversion functions selected; and
convert the luminance of the image using the synthesized function.

2. The image processing device of claim 1, wherein:
the plurality of conversion functions include two or more illumination specific conversion functions determined specifically for illumination in an environment captured by the image; and
the processor is configured to:
acquire illumination information indicating illumination in the environment captured by the image; and
from the plurality of conversion functions, select two or more of the conversion functions including at least one of the illumination specific conversion functions according to the illumination information.

3. The image processing device of claim 1, wherein:
the plurality of conversion functions includes a global conversion function that converts luminance uniformly for an entirety of the image; and
the processor is configured to select two or more of the conversion functions including at least one of the two or more time band specific conversion functions and the global conversion function.

4. The image processing device according to claim 3, wherein:
the processor is configured to generate the global conversion function based on a luminance histogram indicating a distribution of respective luminances for each pixel in the image.

5. The image processing device of claim 1, wherein:
the plurality of conversion functions include a local conversion function that converts luminance by part of the image; and
the processor is configured to select two or more of the conversion functions including at least one of the two or more time band specific conversion functions and the local conversion function.

6. The image processing device of claim 5, wherein the processor is configured to generate the local conversion function based on a luminance histogram indicating a distribution of respective luminances for each pixel by part the image.

7. An image processing method comprising:
acquiring an image aiding a field of view of a driver of a vehicle, and time information of a point in time when the image was captured;
selecting, from a plurality of conversion functions that convert luminance of the image using mutually different characteristics and that include two or more time band specific conversion functions determined specifically for time bands in a one day period, two or more of the conversion functions including at least one of the two or more time band specific conversion functions according to the time information;
generating a synthesized function using the two or more conversion functions selected; and
converting the luminance of the image using the synthesized function.

8. A non-transitory storage medium stored with a program executable by a computer so as to execute processing, the processing comprising:
acquiring an image aiding a field of view of a driver of a vehicle, and time information of a point in time when the image was captured;
selecting, from a plurality of conversion functions that convert luminance of the image using mutually different characteristics and that include two or more time band specific conversion functions determined specifically for time bands in a one day period, two or more of the conversion functions including at least one of the two or more time band specific conversion functions according to the time information;
generating a synthesized function using the two or more conversion functions selected; and
converting the luminance of the image using the synthesized function.
